(19) United States
(12) Patent Application Publication
(10) Pub. No.: US 2011/0153706 A1
(43) Pub. Date: Jun. 23, 2011

(54) FAST FOURIER TRANSFORM ARCHITECTURE

(75) Inventor: Jerry William Yancey, Rockwall, TX (US)

(73) Assignee: L3 Communications Integrated Systems, L.P., Greenville, TX (US)

(21) Appl. No.: 12/643,479

(22) Filed: Dec. 21, 2009

(51) Int. Cl. G06F 17/14

(52) U.S. Cl. 708/404; 708/406

(57) ABSTRACT

A fast Fourier transform (FFT) architecture operable to transform data of variable point size includes a plurality of input ports, a plurality of memory elements, a crosspoint switch, a plurality of processing elements, and a plurality of output ports. The inputs ports read time-domain data from an external source. The memory elements store input data, intermediate calculation results, and output data. The crosspoint switch allows data to flow from any one architecture component to any other architecture component. The processing elements perform the FFT calculation. The output ports write frequency-domain data to an external source.

### BACKGROUND OF THE INVENTION

1. Field of the Invention

Embodiments of the present invention relate to a fast Fourier transform architecture. More particularly, embodiments of the present invention relate to an architecture operable to compute a fast Fourier transform that includes a crosspoint switching element.

2. Description of the Related Art

Digital signal processing architectures generally include a plurality of registers, general-purpose processing elements, and memory cells. The processing elements may not include multiplication units or multiply-accumulate units that are optimized for repetitive multiply and accumulate operations. In addition, there may be a single bus that connects the registers, the processing elements, and the memory cells that does not allow more than one data transfer at the same time. Efficient computation of the fast Fourier transform requires optimized arithmetic components and data pathways since the fast Fourier transform relies heavily on arithmetic operations, particularly multiplication, as well as large volumes of data transferring between the processing elements and the memory.

### SUMMARY OF THE INVENTION

Embodiments of the present invention solve the above-mentioned problems and provide a distinct advance in the art of digital signal processing (DSP) architectures. More particularly, embodiments of the invention provide an architecture for computing a fast Fourier transform (FFT) of variable point size that includes a crosspoint switching element and variable radix-size processing elements.

The architecture includes a plurality of input ports, a plurality of memory elements, a crosspoint switch, a plurality of processing elements, and a plurality of output ports. The inputs ports read time-domain data from an external source. The crosspoint switch acts as a connection fabric that connects all the other components together and allows the time-domain data from the input ports to be stored in a portion of the memory elements. Once a sufficient amount of data has been stored in the memory elements to begin the FFT calculation, data is forwarded from the memory elements to a portion of the processing elements, depending on the delay time of the FFT calculation that is desired. If a short calculation time is required, then multiple processing elements can operate in parallel. Otherwise, one FFT calculation is performed per processing element. Thus, it is possible that multiple FFT calculations can be performed simultaneously.

The FFT calculation is generally performed in stages. In between each stage of the calculation, data is temporarily stored though the crosspoint switch into a portion of the memory elements. After the appropriate number of stages of calculations have been performed, the FFT computation is complete and the resulting frequency domain data is sent to the output ports and written to an external source.

This summary is provided to introduce a selection of concepts in a simplified form that are further described below in the detailed description. This summary is not intended to identify key features or essential features of the claimed subject matter, nor is it intended to be used to limit the scope of the claimed subject matter.

Other aspects and advantages of the present invention will be apparent from the following detailed description of the preferred embodiments and the accompanying drawing figures.

### BRIEF DESCRIPTION OF THE DRAWING FIGURES

Embodiments of the present invention are described in detail below with reference to the attached drawing figures, wherein:

FIG. 1 is a block diagram of the fast Fourier transform processing architecture constructed in accordance with various embodiments of the invention; and

FIG. 2 is diagram of a radix-2 butterfly processor.

The drawing figures do not limit the present invention to the specific embodiments disclosed and described herein. The drawings are not necessarily to scale, emphasis instead being placed upon clearly illustrating the principles of the invention.

### DETAILED DESCRIPTION OF THE PREFERRED EMBODIMENTS

The following detailed description of embodiments of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

The fast Fourier transform (FFT) calculation is an efficient algorithm to calculate the discrete Fourier transform (DFT). For a discrete time-domain sequence of N complex numbers, x₀, x₁, . . . , x_{N-1} the DFT transforms the numbers into a discrete frequency-domain sequence of N complex numbers, X₀, X₁, . . . , X_{N-1}. The DFT is given by EQ. 1:

$${X}_{k} = {\sum }_{n = 0}^{N - 1} {x}_{n} {e}^{- \frac{2 π i}{N} kn} \qquad EQ . 1$$

where e is the base of the natural logarithm and i is the imaginary unit (i=\sqrt{−1}). If W_{N} is substituted for

$${e}^{\frac{- 2 π}{N} i} ,$$

then EQ. 1 becomes:

$${X}_{k} = {\sum }_{n = 0}^{N - 1} {x}_{n} {W}_{N}^{kn} \qquad EQ . 2$$

The FFT calculation recognizes the symmetric and periodic properties of the W_{N}^{kn} term and reduces the number of operations, particularly time-consuming complex multiplication, that need to be performed to calculate the DFT.

The term N is the amount of data, or the quantity of numbers, to be transformed. N is referred to as the point size and is typically a power of 2. Point sizes of 512, 1,024, and 2,048 are common.

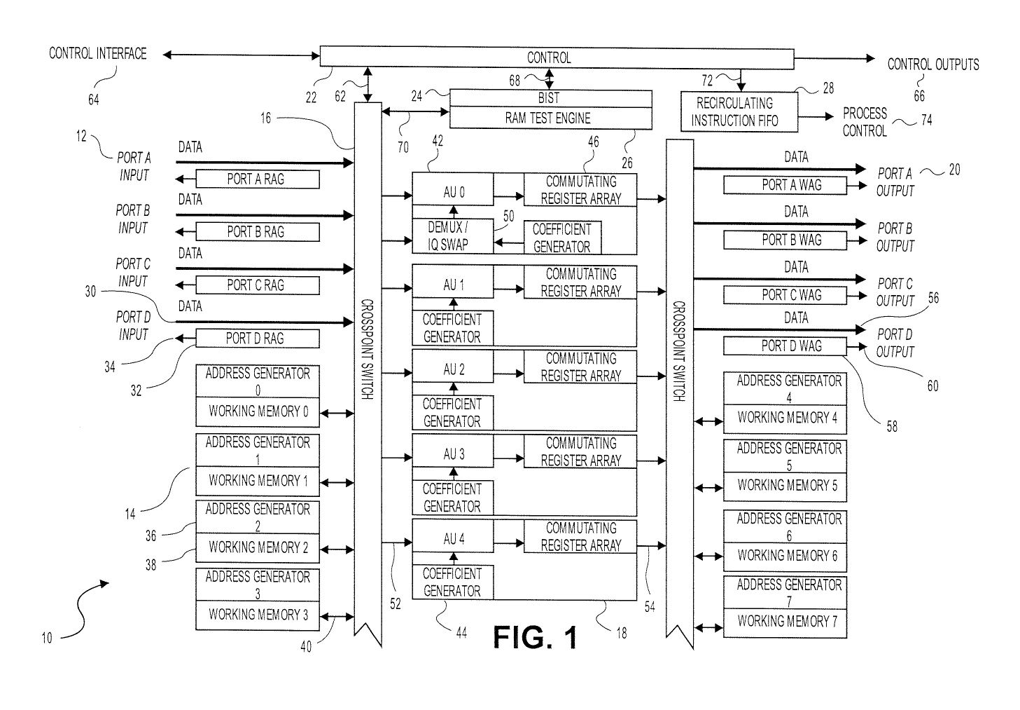

FIG. 1 shows an FFT processing architecture 10 constructed in accordance with various embodiments of the present invention. As defined herein, architecture refers to software implementations, such as consecutively or concurrently executed code segments, firmware implementations, or hardware implementations, such as circuits or subcircuits implemented from fully-custom integrated circuits (ICs), application-specific integrated circuits (ASICs), field-programmable gate arrays (FPGAs), programmable logic devices (PLDs), combinations thereof, and the like.

The architecture 10 includes a plurality of input ports 12, a plurality of memory elements 14, a crosspoint switch 16, a plurality of processing elements 18, and a plurality of output ports 20. The architecture 10 also can include a control unit 22, a built-in self test (BIST) unit 24, a random-access memory (RAM) test engine 26, and a recirculating instruction first-in, first-out (FIFO) register 28.

In various embodiments, the architecture 10 includes four input ports 12, although greater or fewer are possible depending on system-level requirements. For example, if more FFT calculations are required to be performed in parallel, then more input ports 12 may be included. The input port 12 includes a data-in bus 30 and a read address generator (RAG) 32. The input port 12 is operable to read time-domain data from an external source on the data-in bus 30. The bus 30 may include a plurality of lines, where each line is operable to transmit one bit of information. To those skilled in the art, this is also known as the bit width of the bus. Typically, the bus 30 has a number of lines, or width, that is equal to a power of 2. For example, the data-in bus 30 may include 64 lines, or 64 bits wide. The data-in bus 30 also connects to the crosspoint switch 16.

The RAG 32 is operable to transmit a sequence of addresses to the external source where the time-domain data resides in order to retrieve the time-domain data. In various embodiments, the RAG 32 receives instructions from the control unit 22 that controls the operation of the RAG 32. Typically, the RAG 32 includes control logic that generates the appropriate addresses and sends them to the external source through an output port 34. The external source then supplies the requested data to the data-in bus 30. The port 34 may include a bus of variable width to match the specifications of the external source. In various embodiments, it is possible that the RAG 32 does not generate addresses to transmit to an external source, but generates handshaking signals such as, for example, a ready to receive data signal, a data received signal, etc.

In various embodiments, the architecture 10 includes eight memory elements 14, although greater or fewer are possible depending on system-level requirements. For example, if greater throughput of the FFT calculation is required, then more memory elements 14 may be included. The memory element 14 comprises an address generator 36 and a memory cell 38. The address generator 36 is coupled to the memory cell 38 and generates the address of the memory cell 38 to which data is to be written or read. The memory element 14 may receive instructions from the control unit 22 that control the operation of the address generator 36, such as initiation or termination of the storage or retrieval of data from the memory element 14.

The address lines of the memory cell 38 are coupled to the address generator 36. The data lines of the memory cell 38 are coupled in a bi-directional fashion to the crosspoint switch 16 to create a memory data port 40. The number of data lines, or the data bus width, typically matches the width of the crosspoint switch 16. The number of addresses of the memory cell 38 may be varied to accommodate varying constraints. A larger point-size FFT calculation may require a larger memory cell 38. But constraints such as smaller physical size or lower power consumption may result in a smaller number of addresses in the memory cell 38.

The memory cell 38 may include a static RAM (SRAM) structure, a dynamic RAM (DRAM) structure, a register set structure, combinations thereof, and the like. The memory cell 38 may also include multiple ports that allow data to be read from one address while data is being written to another address.

In various embodiments, the architecture 10 includes five processing elements 18, although greater or fewer are possible depending on system-level requirements. For example, as with the memory elements 14, if greater throughput of the FFT calculation is required, then more processing elements 18 may be included.

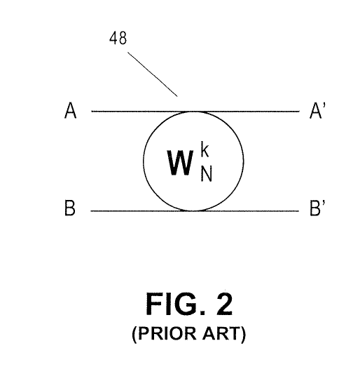

In certain embodiments, the processing element 18 includes an arithmetic unit 42, a coefficient generator 44, and a commutating register array 46. The processing element 18 is operable to compute a portion of the FFT calculation, which is generally determined by the radix number of the arithmetic unit 42. The radix number indicates the number of points that are computed in parallel at roughly the same time. The computation is executed in a circuit known as a butterfly processor. A radix-2 butterfly processor 46, as seen in FIG. 2, computes two points of the FFT calculation. A radix-4 butterfly processor computes four points of the FFT calculation. Higher radix values are possible as well.

Since an FFT calculation of more than two or four points is generally desired, the radix-2 or radix-4 is utilized multiple times to complete a larger-sized calculation. The calculation is performed in stages, wherein each stage computes a portion of the calculation for all N points. There are N/2 radix-2 computations per stage and log₂ N stages for a radix-2 processing architecture 10. Likewise, for a radix-4 processing architecture 10, there are N/4 radix-4 computations per stage and log₄ N stages. Various embodiments of the arithmetic unit 42 include a radix-2 butterfly processor 48. Other embodiments of the arithmetic unit include a radix-4 butterfly processor. Still other embodiments include a combination of the radix-2 butterfly processor 48 and the radix-4 butterfly processor.

The radix-2 processor operation, as illustrated in FIG. 2, can be summarized by EQ. 3 and EQ. 4:

A′=A+W_{N}^{k}B EQ. 3

B′=A−W_{N}^{k}B EQ. 4

where W_{N}^{k} is considered the coefficient, sometimes known as the twiddle factor. A and B are time-domain data inputs in the first stage of calculations and, in subsequent stages, A and B are intermediate FFT calculation values, computed in previous stages. Generally, the inputs A and B are taken from points (in the first stage), or butterfly processor outputs (in subsequent stages) that are spaced N/2 points apart.

The radix-2 butterfly processor may include one or more adder units, one or more multiplier units, and a plurality of registers for temporary storage to execute the operations of EQ. 3 and EQ. 4. The structure of the adder units and multiplier units may vary depending on the type of number system used, for example, fixed-point or floating-point, as those skilled in the art can appreciate.

The radix-4 butterfly processor can be derived from the radix-2 butterfly processor 48. It is possible that, in a logic sense, the radix-4 calculation can be considered a 4-point FFT calculation that uses two stages of two radix-2 butterfly processors 48 per stage. However, the radix-4 processor may use a different hardware implementation than simply instancing four radix-2 processors 48. Thus, the radix-4 butterfly processor may include one or more adder units, one or more multiplier units, and a plurality of registers for temporary storage that form a different structure from the radix-2 butterfly processor 48.

The coefficient generator 44 is operable to supply coefficients (W_{N}^{k} from EQ. 3 and EQ. 4) for the FFT computation to the arithmetic unit 42 that may include either a radix-2 or radix-4 butterfly architecture. The coefficient generator 44 may include a memory unit that is sufficiently sized to store all the coefficients necessary for the largest of the FFT point sizes to be calculated. The coefficient generator 44 may also include an address generating control unit that is operable to access the appropriate coefficient to be supplied to the arithmetic unit 42.

The commutating register array 46 is an array of registers that is operable to provide temporary local data storage and to locally reorder data flow. The commutating register array 46 may include a plurality of memory cells that select data as input from a plurality of sources. The commutating register array 46 may also have a plurality of outputs that receive data from the plurality of registers.

Various embodiments of the processing element 18 include a demultiplexing (demux)/in-phase, quadrature (IQ) swap unit 50. The data used in the FFT processing architecture 10 may include complex numbers, which include an in-phase, or also known as real, portion and a quadrature, or also known as complex, portion. It is possible that the in-phase and quadrature components of a complex number might need to be swapped for certain operations. The demux/IQ swap unit 50 performs the swap and includes a demux circuit that has a plurality of outputs and is operable send the swapped data to any of the outputs.

The processing element 18 also includes an input port 52 and an output port 54 that both connect to the crosspoint switch 16. Various embodiments of the processing element 18 may include a plurality of input ports 52. In addition, the processing element 18 may receive instructions from the control unit 22 that control the operation of the processing element 18, such as managing the flow of data through the arithmetic unit 42.

The crosspoint switch 16 is operable to provide communication between some or all the components of the data path, i.e. the input ports 12, the memory elements 14, the processing elements 18, and the output ports 20. The crosspoint switch 16 may include a plurality of switching elements such that an output of the switch 16 may receive data from any switch 16 input. For example, the processing element input port 52 may be considered an output from the switch 16. Thus, the processing element input port 52 may receive data from any of the switch 16 inputs, including the input ports 12 or the memory elements 14. The width of the pathways of the crosspoint switch 16 is generally the same as the width of the ports and busses of the other components of the architecture 10.

The crosspoint switch 16 may include multiplexing (MUX) elements that select one of many inputs to be transferred to the output. The switch 16 may include demultiplexing elements that select one of many outputs to receive data from the input. The switch 16 may also include combinations of mux/demux elements or other data routing components.

In various embodiments, the architecture 10 includes four output ports 20, although greater or fewer are possible depending on system-level requirements. Likewise with the input ports 12, if more parallel FFT calculations are required, the more output ports may be included. The output port 20 includes a data-out bus 56 and a write address generator (WAG) 58. The output port 20 generally receives the results of an FFT calculation, which is frequency-domain data, through the crosspoint switch 16 from one of the memory elements 14. The data is transferred to one of the data-out busses 56.

The WAG 58 is operable to transmit a sequence of addresses to an external source in which the frequency-domain data is to be written. In various embodiments, the WAG 58 receives instructions from the control unit 22 that control the operation of the WAG 58. Typically, the WAG 58 includes control logic that generates the appropriate addresses and sends them to the external source through an output port 60. The output port 60 may include a bus of variable width to match the specifications of the external source. In various embodiments, it is possible that the WAG 58 does not generate addresses to transmit to an external source, but generates handshaking signals such as, for example, a ready to write data signal, a data sent signal, etc.

The control unit 22 is operable to manage the operation of the FFT processing architecture 10. In various embodiments, the control unit 22 is operable to control functions, such as transferring data from a memory element 14 to a processing element 18, by transmitting instructions to the components of the architecture 10 through a control port 62 that is coupled to the crosspoint switch 16. In addition, the control unit 22 is operable to control the settings of the crosspoint switch 16. The control unit 22 may send control signals to the switching components of the crosspoint switch 16 in order to control the flow of data from one component to another.

In various embodiments, the FFT processing architecture 10 is cascadable with other data processing systems, such as additional FFT processing architectures or systems that calculate other mathematical functions. The control unit 22 has the ability to communicate and coordinate with other systems through the control interface port 64 and the control outputs port 66. For example, the control unit 22 may communicate with other systems that perform a filtering function both before and after the FFT is calculated. The control unit 22 may send and receive control signals to the other systems that allow filtered data from a pre-FFT filter to be transmitted to the FFT processing architecture 10 in a streaming fashion and fast-Fourier transformed data to be transferred from the architecture 10 to another system that performs post-FFT filtering.

The control unit 22 may include components such as microcontrollers, microprocessors, FPGAs, PLDs, combinational logic coupled with finite state machines (FSMs), combinations thereof, and the like.

The BIST unit 24 is operable to test the operation of the control unit 22 through a bi-directional test port 68 that is coupled to the control unit 22. In various embodiments, the BIST unit 24 generates a sequence of test vectors, which may include a pattern of binary data in serial or parallel form, that generally follow a path through the control unit 22 and are transmitted back to the BIST unit 24. The BIST unit 24 may then analyze the return data, comparing it to the pattern that was transmitted to the control unit 22. If there are any differences found, the BIST unit 24 may transmit an error signal to an external monitor. The BIST unit 24 may be used to isolate low-level physical problems such as stuck-at or bridging faults, high-level problems such as logical errors.

The BIST unit 24 may include components such as microcontrollers, microprocessors, FPGAs, PLDs, combinational logic coupled with FSMs, combinations thereof, and the like.

The RAM test engine 26 is operable to test the data integrity of the memory elements 14. The RAM test engine 26 includes a bi-directional test port 70 that is coupled to the crosspoint switch 16. In various embodiments, the RAM test engine 26 generates a sequence of test vectors, which may include a pattern of binary data in serial or parallel form, that are generally written to every location in the memory cell 38 of the memory element 14 under test. These vectors are sent from the RAM test engine 26 to the memory element 14 through the crosspoint switch 16. The vectors are then read back out from the memory element 14 to the RAM test engine 26, where they are compared with the original patterns. The test may be used to isolate low-level physical problems such as stuck-at or bridging faults.

The RAM test engine 26 may include components such as microcontrollers, microprocessors, FPGAs, PLDs, combinational logic coupled with FSMs, combinations thereof, and the like.

The recirculating instruction FIFO 28 receives instructions from the control unit 22 through a control instruction port 72. The recirculating instruction FIFO 28 is a first-in, first-out type of register wherein the data is stored in the register in the order in which it is received. Instructions may be transferred to the recirculating instruction FIFO 28 when they cannot be executed by the control unit 22. The instructions may be transferred through a process control port 74 to an external source, where it is possible that the instructions may be executed at a later time.

The recirculating instruction FIFO 28 may include a plurality of registers or memory cells that are configured in an automatic shift register fashion such that the first instruction to be received on the control instruction port 72 is the first piece of data to be transferred out of the process control port 74.

The FFT processing architecture 10 may operate as follows. A quantity of data to be fast Fourier transformed is transferred to the data-in bus 30 of any of the input ports 12. The RAG 32, as instructed by the control unit 22, may generate a sequence of addresses to the external source in order to access the proper time-domain data. The control unit 22 issues instructions to the crosspoint switch 16 to establish the proper path for the data coming in on the data-in bus 30. In various embodiments, the data may be routed to the processing element 18. In other embodiments, the data may be routed to one or more memory elements 14 until at least a substantial portion of the data has been stored. At that point, data may be transferred from the memory element 14 through the crosspoint switch 16 to the processing element 18.

The control unit 22 determines the components that are necessary to compute the FFT based on user demands and system resources. The control unit 22 may allocate the radix-2 butterfly processor 48 or the radix-4 butterfly processor or a combination of both. If greater throughput is desired, a mixed radix-2 and radix-4 computation might be implemented. If greater capacity (FFT calculations performed in parallel) is desired, then either only the radix-2 or the radix-4 processor might be used. It is also possible that the control unit 22 decomposes a larger point-size FFT computation into a series of smaller-sized FFTs and reconfigures the data flow to manage the computation.

The arithmetic unit 42 begins the FFT computation with coefficients supplied by the coefficient generator 44 as necessary and data reordered by the commutating register array 46 as necessary. The intermediate computation results might be stored in a separate memory element 14 from the memory element 14 that stores the source data. For example, the source data may be stored in memory element #0 as labeled in FIG. 1. The intermediate results may be stored in memory element #4 from FIG. 1. This flow of data may continue until all the computations for a stage of the FFT calculation are complete.

At this point, memory element #4 may act as the source of data for the next stage of computations, sending data back to the processing element 18 through the crosspoint switch 16 and storing the next stage of computation results in memory element #0. Operation of the architecture 10 may continue in this fashion repeatedly, with data flowing from one memory element 14 through the processing element 18 to perform partial FFT computations and then to another memory element 14 to store a stage of calculation results, until all stages are complete and the FFT calculation is finished.

As the final stage of an FFT calculation is executing, data may flow from the processing element 18 to an output port 20. The WAG 58 may generate a sequence of addresses in which the calculations are to be stored in an external source. Data flows through the data-out bus 56 to the external source until all the data is transmitted.

In some instances, the FFT calculation results may flow from the processing element 18 to a memory element 14 if it is not possible to transmit the FFT results, because all the output ports 20 may be busy, for example. The results are then transferred from the memory element 14 through the crosspoint switch 16 to the output port 20 as soon as one of the ports becomes available. The results are transmitted to an external source as described above.

Although the invention has been described with reference to the preferred embodiment illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A fast Fourier transform processing architecture, comprising:
a plurality of processing elements operable to compute a portion of a fast Fourier transform, each processing element including:
an arithmetic unit operable to perform multiply and accumulate operations that create intermediate fast Fourier transform results,
a coefficient generator operable to provide coefficient factors operable to be utilized in computing a portion of the fast Fourier transform, and
a commutating register array operable to reorder the intermediate fast Fourier transform results;
a plurality of memory elements operable to store intermediate fast Fourier transform results, each including an address generator; and
a crosspoint switching element operable to be programmed to allow communication between the plurality of processing elements and the plurality of memory elements.

2. The fast Fourier transform processing architecture of claim 1, further comprising a control unit operable to control the setting of the switching element.

3. The fast Fourier transform processing architecture of claim 2, further comprising a built-in self test unit operable to provide testing capability to the control unit.

4. The fast Fourier transform processing architecture of claim 1, further comprising a plurality of data input ports in communication with the switching element operable to accept time-domain data.

5. The fast Fourier transform processing architecture of claim 4, wherein each data input port includes a read address generator that is operable to generate a sequence of memory addresses from which data is to be read.

6. The fast Fourier transform processing architecture of claim 1, further comprising a plurality of data output ports in communication with the switching element operable to provide frequency-domain data.

7. The fast Fourier transform processing architecture of claim 6, wherein each data output port includes a write address generator that is operable to generate a sequence of memory addresses to which data is to be written.

8. The fast Fourier transform processing architecture of claim 1, wherein the architecture is operable to perform variable multi-point fast Fourier transform calculations.

9. The fast Fourier transform processing architecture of claim 1, wherein the processing element is operable to perform variable radix-number calculations.

10. The fast Fourier transform processing architecture of claim 1, wherein at least one of the processing elements includes a demultiplexing unit that is operable to receive data from the crosspoint switch and output the data to one of a plurality of demultiplexing unit ports.

11. The fast Fourier transform processing architecture of claim 1, wherein at least one of the processing elements includes an in-phase and quadrature component swap unit that is operable to swap the in-phase and quadrature components of a complex number.

12. The fast Fourier transform processing architecture of claim 1, further comprising a memory test engine operable to provide testing capability to the memory elements.

13. The fast Fourier transform processing architecture of claim 1, further comprising a recirculating instruction first-in, first-out register that is operable to forward instructions to an external process control unit.

14. A fast Fourier transform processing architecture, comprising:
a plurality of processing elements operable to compute a portion of a fast Fourier transform, each processing element including:
an arithmetic unit operable to perform multiply and accumulate operations that create intermediate fast Fourier transform results,
a coefficient generator operable to provide coefficient factors operable to be utilized in computing a portion of the fast Fourier transform, and
a commutating register array operable to reorder the intermediate fast Fourier transform results;
a plurality of memory elements operable to store intermediate fast Fourier transform results, each including an address generator;
a crosspoint switching element operable to be programmed to allow communication between the plurality of processing elements and the plurality of memory elements;
a control unit operable to control the setting of the switching element;
a plurality of data input ports in communication with the switching element operable to accept time-domain data, each data input port including read address generator that is operable to generate a sequence of memory addresses from which data is to be read; and
a plurality of data output ports in communication with the switching element operable to provide frequency-domain data, each data output port including a write address generator that is operable to generate a sequence of memory addresses to which data is to be written.

15. The fast Fourier transform processing architecture of claim 14, wherein the architecture is operable to perform variable multi-point fast Fourier transform calculations.

16. The fast Fourier transform processing architecture of claim 14, wherein the processing element is operable to perform variable radix-number calculations.

17. The fast Fourier transform processing architecture of claim 14, wherein at least one of the processing elements includes a demultiplexing unit that is operable to receive data from the crosspoint switch and output the data to one of a plurality of demultiplexing unit ports.

18. The fast Fourier transform processing architecture of claim 14, wherein at least one of the processing elements includes an in-phase and quadrature component swap unit that is operable to swap the in-phase and quadrature components of a complex number.

19. The fast Fourier transform processing architecture of claim 14, further comprising a memory test engine operable to provide testing capability to the memory elements.

20. The fast Fourier transform processing architecture of claim 14, further comprising a recirculating instruction first-in, first-out register that is operable to forward instructions to an external process control unit.
